(19) United States
(12) Patent Application Publication
(10) Pub. No.: US 2002/0077885 A1
(43) Pub. Date: Jun. 20, 2002

(54) Electronic voting system

(76) Inventors: Jared Karro, Greensboro, NC (US); Jie Wang, Greensboro, NC (US)

Correspondence Address: RHODES & MASON , P.L.L.C., P.O. Box 2974, Greensboro, NC, 27402, US

(21) Appl. No.: 09/731,035

(22) Filed: Dec. 6, 2000

(51) Int. Cl. G06F 17/60

(52) U.S. Cl. 705/12

(57) ABSTRACT

A method of holding an election including enabling voters to register with a registrar facility by providing encryption keys to registered voters and storing the encryption key with an authenticator facility. The method includes distributing ballots having unique ballot ID's to requesting voters, receiving ballots having voter choices on them and encrypted using voters encryption keys, receiving from voters ballot ID, encrypted vote information and, voter ID at an authenticator facility, indications that votes have been cast with a ballots having indicated ballot ID's at a distributor facility, and an indication that the voter has voted at a registrar facility. The method includes authenticating the voter at the authenticator facility and passing authenticated votes and the ballot ID to a counter facility.

### BACKGROUND OF THE INVENTION

(1) Field of the Invention

The present invention relates generally electronic voting system and, more particularly, to a system for carryings out elections over a network.

(2) Description of the Prior Art

Democratic societies are founded on the principle of elections. However, it is not unusual that many eligible voters in a democratic society do not participate in elections. One of the common reasons for not participating is that voters find it inconvenient to go to the polls. In conventional elections, voters must go to a designated location near their residence. However, for various reasons voters are not always able to make it to these locations. They may be out of town on work or on vacation. Even if they are in town, their daily schedule may not permit them to get to the ballots.

With the rapid growth of the Internet, specifically the World Wide Web, voting online provides a reasonable alternative and in the future may replace conventional elections. Voting online would allow voters to participate in an election in any location that provides Internet access. Voters could cast their ballots while at work, at school, or in the comfort of their own home. Many public libraries have computers with Internet access that could also be used in elections. In some places, bookstores and coffee bars are also starting to provide Internet access. For those voters still without Internet access, voting districts would still have designated locations; only computers, instead of voting booths, would be used. There would be no need to restrict voters to a given district.

The idea of electronic election over computer networks has been studied intensively for over fifteen years. A variety of cryptographic voting protocols have been proposed to minimize election fraud and maximize voter privacy (for example, see [Be87, BT94, Ch88b, Co86, CF85, C+96, CGS, CC97, F+93, IV91, MV98, NS91, NS, N+91, Sal96, Sch96, SK94]). Most of the early-proposed protocols only deal with a few certain issues of elections, mostly for theoretical interests. As pointed out in [F+93] and [CC97], such protocols are impractical to implement for a large-scale geographically distributed voting district. For a survey of several such protocols we refer the reader to Chapter 3.2 in Cranor and Cytron's paper [CC97]. So far there has not been a single government election done over the Internet.

Fujioka, Okamoto, and Ohta [F+93] studied how to make online elections practical and proposed a voting protocol using cryptographic techniques of blind signatures and anonymous communication channels. Their protocol also uses central facilities to administrate elections and count votes. They justified that using central facilities is necessary for a voting scheme to be practical. Built on this work, Cranor and Cytron [CC97] recently designed and implemented a security-conscious polling system, called Sensus. However, Fujioka et al.'s protocol and the Sensus protocol suffer from several major drawbacks (we will describe these drawbacks in Chapter III). Some of these drawbacks are due to the use of blind signatures in large scales and the unpractical assumption of using anonymous communication channels (note that CPU identification numbers have been embedded into the new Intel's Pentium III chips that can be broadcast over the Internet). These drawbacks hinder Sensus from being used in large-scale elections.

### CHAPTER III

### EXISTING ELECTRONIC VOTING SCHEMES

A survey of the existing electronic voting schemes follows. Since there are many variations of a few key concepts, we have grouped the voting schemes into groups based on their key techniques. By doing so, we hope to reveal the key drawbacks, as well as the benefits, of the main techniques without delving deep into specific details. A majority of this chapter will focus around Sensus.

Schemes that Use No Central Tabulating Authority

[Sch96] presents a model that uses no central tabulating authorities. As a result, voters are required to do all the work, including performing all the checks and declaring a winner. To make matters even worse, the protocol is too complicated for a layman to understand. All of these factors make any scheme that uses no central tabulating authorities unsatisfactory.

Schemes that Use All-Or-Nothing Disclosure of Secrets (ANDOS)

A number of existing protocols, such as [Sch96, N+91], use a technique known as ANDOS to guarantee anonymity. While the rest of the protocol may be feasible, the use of ANDOS for anonymity is not. The ANDOS protocol is extremely complex, making it unsuitable for large-scale elections. Thus, the presence of ANDOS causes these protocols to fail the scalability requirement.

On the other hand, if ANDOS is removed from these protocols, then the election is no longer anonymous. Therefore, the protocols now fail the privacy criterion. Also, in many cases it may not be possible to simply remove the ANDOS protocol, for otherwise other requirements may be violated.

Schemes that Use Multi-Part Elections

[F+93] suggests a protocol that has several non-parallel phases. As a result, voters cannot proceed to the next phase of voting until the current phase is complete. Instead of the five or ten minutes it takes to cast a conventional ballot, in a large-scale election it could take days for a voter to cast their ballot in this model. With the need to still maintain a common polling area (for those without access to computers), this scheme is extremely inefficient as voters would be required to travel, and wait in lines, for multiple times.

Schemes that Use Homomorphisms or Scamblers

[SK94, CGS, C+96] devise voting schemes that use homomorphisms to protect the anonymity and integrity of the election. The basic idea is to divide a vote into many parts, such that the sum of all its parts is the original vote. There are several problems with using techniques such as this.

First, if all the parties receiving the parts of the election collaborate, then the election could be compromised. Also, since the vote is divided into many parts, and the security of the election is directly proportional to the number of parts, the scalability of such a scheme is hindered.

Large-scale implementation would result in either an insecure implementation, or an extremely costly (in both resources and financial) and time-consuming election. Since our ultimate goal was to devise a scheme that could function in a national, or global, election, the homomorphism approach does not satisfy our requirements.

In addition, these voting protocols are primarily limited to ‘yes-no’ votes. In the majority of the national elections, this is not the case. In addition to having multiple options, many elections also have the ability to ‘write-in’ a candidate. Even though the ability to have a ‘write-in’ candidate is not extremely significant, it is extremely important of our protocol to support multiple candidate elections. This need is evident with the election of the Reform Party's Jesse Ventura as governor of Minnesota.

[Sal96] does not use homomorphisms, but instead uses “scamblers” to protect the anonymity and integrity of the election. Once again, large-scale implementation of this protocol does not seem feasible, as the voter must contact every scambler. In addition, the voter is required to participate in a pre-election phase before every election. Requiring voters to register before every election could possibly result in fewer participants.

Schemes that use Blind Signatures and Anonymous Communication Channels

Many electronic voting protocols have been proposed during the past fifteen years as we mentioned in Chapter I, but none of them seem to fit our set of requirements as nearly as Sensus. Many of these protocols, while of theoretical interest, are not practical to implement for a large number of geographically distributed voters [CC97]. Sensus, on the other hand, has actually been implemented and used in mock elections. Sensus is based on the voting protocol proposed in [F+93], which uses blind signatures and anonymous communication channels to administrate elections. In this chapter we will first outline these two protocols. We will then show that these two protocols suffer from several major drawbacks.

We begin with Fujioka et al.'s protocol [F+93], which consists of voters and three central facilities called registrar, validator, and tallier. Note that in [F+93], the validator is called the administrator and the tallier is called the counter. The registrar compiles a list of eligible voters, which could be performed before the actual election begins. (We note that the registrar facility is not mentioned explicitly in [F+93].) The protocol consists of seven phases outlined below, where the registration phase, not included in [F+93], is added here for completeness as in the Sensus protocol.

Registration Phase.

The registrar compiles a list of eligible voters prior to an election. Eligible voters generate public/private key pairs for signing ballots, and register to vote by sending the registrar their voter identifications and the public keys, which are placed in a registered voter list. (See [CC97] for a detailed implementation of this phase.) The registrar then sends the list to the validator.

Preparation Phase. The voter V prepares a voted ballot b, encrypt it with a random string k he/she selects as in the bit-commitment scheme [Na90]. Assume that the committed ballot is x. The voter then blinds x into a new string e, signs e into a new string s, and sends (I, e, s) to the validator, where I is V's ID.

Authorization Phase.

Using the registered voter list, the validator verifies that the signature s belongs to a registered voter I who has not yet voted, signs the ballot e into a new string d, and returns d to the voter.

Voting Phase.

The voter V retrieves the blinding encryption layer, revealing an encrypted ballot y signed by the validator, and sends the pair (x, y) to the tallier via an anonymous communication channel as described in [Ch81, Ch88a, Pf84].

Collecting Phase.

The tallier checks the signature y, using the validator's public key, to make sure that x is from a legitimate voter, and places (x, y) on a list of valid ballots.

Opening Phase.

At the end of the election, the validator publishes the number of voters who were given the administrator's signature, and publishes a list of all triples (I, e, s) it has received; and the tallier publishes the list of valid ballots. The voter V then checks that the length of the list is equal to the number of voters, and that his/her vote (x, y) appears on the tallier's list, with index n. The voter then sends (n, k) to the tallier via an anonymous communication channel.

Counting Phase.

The tallier decrypts the corresponding committed ballot x using k and retrieves the ballot b, counts the votes, and announces the voting results.

The Sensus protocol, for a large part, is the same as Fujioka et al.'s protocol. It assumes that all communication between voter and election authorities occurs over an anonymous channel. What is different in Sensus is that it uses one extra central facility called pollster and that the tallier does not wait to the end to process votes. The latter is done by modifying the opening and counting phases. In particular, after the collecting phase, the tallier signs the encrypted ballot x and returns it to the voters as a receipt. Upon receiving the receipt, the voter sends the tallier the ballot decryption key k, and the tallier uses the key to decrypt x to obtain b and add the vote to the tally. Sensus still relies on voters to perform verification as in the opening phase of Fujioka et al.'s protocol. The pollster acts as a voter's agent, performing all cryptographic and data transfer functions on a voter's behalf.

Next, we show that using blind signatures as in these two protocols would allow the tallier to cheat the election without been detected. We note that in the preparation phase, if several voters would choose the same random keys k and vote in the same marner, then their encrypted ballots x will be exactly the same, and so they will obtain the same y with the validator's signature. The tallier can then replace a few (not all) of these pairs (x, y) with some other legitimate pairs (x′, y′). When each of the affected voters checks for its vote, he/she will see (x, y) in the published list and hence will not detect anything wrong. To make matters worse, the tallier may generate new votes to replace duplicated votes. Since voters would use the same pseudo-random number generator provided by the system to generate secret keys k, and since in a large-scale election many of the votes will be the same, it is likely that many of the pairs (x, y) will be the same. This would make the attack successful, which would violate the accuracy criterion.

Fujioka et al. [F+93] noted that the validator could submit votes for voters who decide to abstain. They then suggested that voters who abstain should submit a blank ballot to avoid this from happening. This is hardly a practical solution because if the voters decide to abstain, they probably would not take the time to submit blank ballots either. Likewise, the voters who abstain cannot be relied upon to make sure that no votes were cast for them. To solve this problem, it may be possible to have some sort of time expiration on the ballots. This, however, may generate more problems.

Another drawback with the Sensus protocol and Fujioka et al.'s protocol is that they rely on anonymous communication channels to provide anonymity. But anonymity is hard to guarantee over the Internet. Although there are services that offer the ability to browse the Web anonymously, such as anonymizer.com, the only way to guarantee that all voters use these services is to force them to use certain sites. However, voters cannot know, with any certainty, that these sites do not collaborate with any of the central facilities involved. Cranon and Cytron [CC97] suggest that an anonymous channel could be secured through the use of a chain of World Wide Web facilities. The problem with this solution is that some organization must configure this to occur. It would be difficult to ensure the voters that none of the Web facilities in the chain are secretly collaborating with the authority. The task of anonymity on the Web may have been made even more complicated with the recent introduction of embedding CPU identification numbers into Intel's Pentium III chips. These numbers can be broadcast over the Internet, identifying the voter's Internet connection and the machine from which they are casting their votes. This would violate the privacy criterion.

Finally, in these two protocols, voters are relied upon to verify that their votes were counted. This is not practical, especially for voters who do not have convenient Internet access. These voters would have to revisit a polling place to verify their votes after the voting results are announced. Therefore, Sensus violates the simplicity and the verifiability criteria.

Thus, there remains a need for a new and improved voting system that is secure while at the same time usable in large-scale elections. The present invention includes a new design for an electronic voting system. The voting system uses central facilities, but it does not use blind signatures or anonymous communication channels.

### SUMMARY OF THE INVENTION

The present invention fulfills this need in the art by providing a method of holding an election including enabling voters to register with a registrar facility by providing encryption keys to registered voters and storing the encryption key with an authenticator facility. The method includes distributing ballots having unique ballot ID's to requesting voters, receiving ballots having voter choices on them and encrypted using voters encryption keys, receiving from voters ballot ID, encrypted vote information and, voter ID at an authenticator facility, indications that votes have been cast with a ballots having indicated ballot ID's at a distributor facility, and an indication that the voter has voted at a registrar facility. The method includes authenticating the voter at the authenticator facility and passing authenticated votes and the ballot ID to a counter facility.

In a preferred embodiment the method includes decrypting votes at the counter facility and tallying a number of votes, publishing a list containing encrypted votes and ballot ID's at the authenticator facility, publishing a list containing encrypted votes and ballot ID's at the counter facility, publishing a list containing voter ID's of cast ballots at the authenticator facility, examining the list containing voter ID's of cast ballots at the registrar facility to confirm that only registered voters voted, verifying at a verifier facility that the list containing encrypted votes and ballot ID's published at the authenticator facility is identical to the list containing encrypted votes and ballot ID's published at the counter facility, confirming at the verifier facility from the list containing encrypted votes and ballot ID's published at the authenticator facility and a decryption table the results published by the counter facility, examining at the distributor facility the list containing encrypted votes and ballot ID's published at the authenticator facility and the list containing encrypted votes and ballot ID's published at the counter facility to ensure that only legitimate ballots appear, and releasing the election results at the counter facility.

Typically, at least one of the distributing and receiving steps includes transmitting information over the Internet. Preferably, distributing ballots includes distributing a number of ballots from an inventory of ballots that has more members than there are registered voters. Distributing ballots may includes distributing a ballot having a ballot number, and a matching pair made up of plain-text versions of ballot choices and encrypted versions of ballot choices. Preferably, the encrypted version is encrypted using an encryption key unique to the ballot. The ballot choices may include ballot choices in municipal and national elections. Desirably, the acts of publishing include publishing to the general public. Preferably, passing authenticated votes includes passing data through a firewall.

The invention also provides an election apparatus including a network of data handling devices configured to hold elections including a data handling device enabling voters to register with a registrar facility including providing encryption keys to registered voters and storing the encryption key with an authenticator facility, a data handling device distributing ballots having unique ballot ID's to requesting voters, a data handling device receiving ballots having voter choices on them and encrypted using voters encryption keys, data handling devices configured as authenticator, distributor and registrar facilities enabled to receive from voters ballot ID, encrypted vote information and, voter ID at the authenticator facility indications that votes have been cast with a ballots having indicated ballot ID's at the distributor facility, and an indication that the voter has voted at the registrar facility, to authenticate the voter at the authenticator facility and passing authenticated votes and the ballot ID to a data handling device configured as a counter facility.

In a preferred embodiment at least two of the data handling devices communicate information to one another over the Internet. The data handling device that distributes ballots typically distributes a number of ballots from an inventory of ballots that has more members than there are registered voters. Desirably, the ballot has a ballot number, and a matching pair made up of plain-text versions of ballot choices and encrypted versions of ballot choices. The encrypted version may be encrypted using an encryption key unique to the ballot. The ballot choices include ballot choices in municipal and national elections.

In a preferred embodiment the authenticator (as well as other facilities) is protected by a firewall.

These and other aspects of the present invention will become apparent to those skilled in the art after a reading of the following description of the preferred embodiment when considered with the drawings.

### BRIEF DESCRIPTION OF THE DRAWINGS

FIG. 1 is a block diagram illustrating communication between facilities during the registration phase according to an aspect of the present invention;

FIG. 2 is a block diagram illustrating interaction between facilities during the pre-voting phase according to an aspect of the present invention;

FIG. 3 is a block diagram illustrating interaction between facilities during the voting phase according to an aspect of the present invention; and

FIG. 4 is a sample ballot and a sample matching pair according to an aspect of the present invention.

DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

### CHAPTER II

### SYSTEM REQUIREMENTS

A good electronic voting system should not sacrifice voter privacy or introduce opportunities for fraud. For an electronic voting system to be useful and acceptable by voters, it must be at least as secure as conventional voting systems. We use the following set of nine criteria to ensure that an electronic voting system is secure and practical for large-scale elections.

Democracy: Only eligible voters are permitted to vote, and they can do so only once.

Accuracy: A voter's vote cannot be altered, duplicated, or removed without being detected. Invalid votes are not tabulated in the final tally.

Privacy: Votes remain anonymous.

Verifiability: Voters can be sure that their votes are tabulated correctly, but voters are not required to verify their votes in order to ensure election integrity.

Simplicity: Voters can finish voting quickly, with minimal equipment or special skills.

Mobility: Voters are not restricted to physical location from which they can cast their votes

Efficiency: The election can be held in a timely manner (i.e. all computations during the election are done in a reasonable amount of time and voters are not required to wait on other voters to complete their ballot).

Scalability: The size of the election will not drastically affect performance.

Responsibility: Eligible voters who have not voted can be identified. (This is an optional requirement.)

Among these criteria, democracy, accuracy, privacy, verifiability, simplicity, and mobility are directly relevant to the voters, which are adapted from [CC97]. The criteria of efficiency, scalability, and responsibility are added to our system.

For the privacy criterion, we may further require that no voter can prove that he or she voted in a particular way to prevent vote buying and extortion. But as pointed out in [CC97], unless voters are required to cast their votes from inside a solitary voting booth, voters will be able to prove how they voted by allowing buyers to observe them while they are casting their votes. Adding this requirement would comprise mobility, one of the major reasons to hold an online election.

The current US government elections do not satisfy the verifiability criterion. If an election booth has malfunctions, for example, then some voters' ballots may not be counted correctly and the voters are not able to detect the error. In the past, elections have also been held in which ineligible voters, even the deceased, have been allowed to cast a vote.

Conventional election systems also do not handle mobility easily. For those voters who will not be in their home districts during the election and wish to vote, they must file absentee ballots. But due to time constraints, this may not always be possible, as their absence may not be known until the last minute.

The criteria of simplicity, efficiency, and scalability imply that in such a voting system, voters cannot be required or expected to communicate with other voters; and voters cannot be required to do all the computations of the election. This means that some central facilities must be employed in the system.

The responsibility criterion is not required in US elections, but it is required in Australian elections. By Australian laws, eligible voters are required to participate in government elections; they are subject to punishment if they do not participate without acceptable reasons [MV98]. By adding this criterion, our election scheme could be used around the world and in many different styles of elections. The current US voting system actually allows a list of participating voters to be generated, since voter names are crossed off of a list prior to them actually casting their ballot.

### CHAPTER IV THE PROPOSED PROTOCOL

Our protocol does not use blind signatures or require anonymous communication channels. Instead, our protocol uses a secure form of communication (e.g. HTTPS in Netscape) for all transactions. Our protocol consists of only four phases (procedures), which are explained below. The phases are registration, pre-voting, voting, and announcement.

For clarity, our protocol uses six central facilities. They are the registrar, the authenticator, the distributor, the counter, the matcher, and the verifier. The responsibilities of these facilities will become clear when the protocol phases are described. To reduce costs, in actual implementation it may be possible to combine some facilities, but in doing so one must first ensure that the combined facility will not have access to extra information that would allow the facility to compromise the election process in any way.

Registration Phase

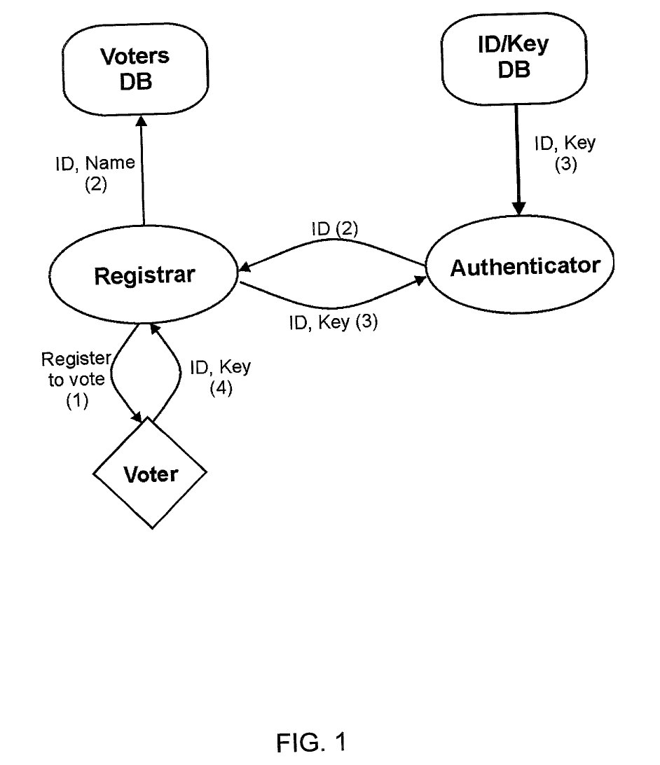

There are four steps involved in the registration phase. The voter only participates in two of the steps. FIG. 1 shows a visual representation of the communication between the acting facilities.

1. In order to vote, a voter must first register with the registrar to identify himself as an eligible voter.

2. Upon registering, the registrar assigns a unique identification number to the voter, places the voter's name and ID in the registered voter list, and sends the ID without the name to the authenticator.

3. The authenticator generates a unique pair of public/private keys for the ID it received, stores them in a list, and sends the pair of the public key s and the ID to the registrar.

4. The registrar then sends the pair back to the voter. (In so doing, the authenticator will not know whom the given key s belongs to without conspiring with the registrar.)

Until everyone has their own digital signatures, it would be impossible to register votes without forcing them to go to the DMV or other such agency, so that their identity could be verified. If all parties already had digital signatures, these could be used to electronically verify their identity.

Remark.

The key s may be valid for a long time for multiple elections, or could expire after a given time. If the key were to be kept for a long duration, it would probably be best to have the voter encrypt it with a password of his/her choice, so that no one else could use it. The original, unencrypted key would be destroyed and the encrypted key (still denoted by s) would be stored instead. The voter-encrypted key could be stored on the voter's license or identification card. Even if a license were stolen, a thief would not be able to vote as the voter, since the voter's key is encrypted. A thief would not know they had entered the wrong password until they were informed that they could not be authenticated. In addition, when the individual whose license was lost or stolen goes to get a new license, they would also be forced to re-register. They would be awarded a new key, and their old key would be revoked.

Pre-Voting Phase.

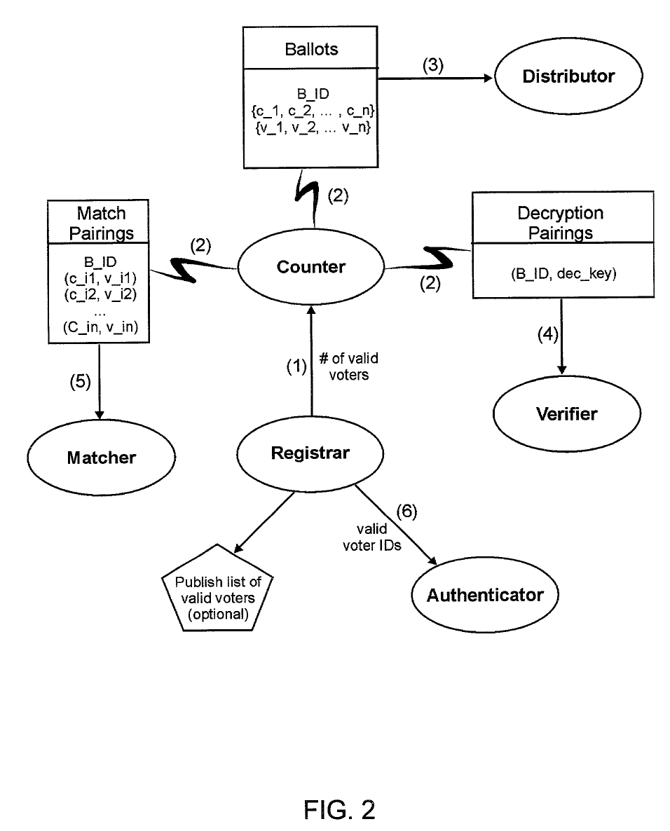

The pre-voting phase consists of six steps, with a seventh optional step. See FIG. 2 for a visual representation of the facility interaction.

1. The registrar sends the number of eligible registered voters to the counter.

2. The counter generates a larger number of ballots than the number of registered voters. Each ballot consists of three things: each of the choices on the ballot, an encrypted version of each choice, and a ballot ID. The counter keeps record of the decryption key and the ballot ID for each ballot so that the counter can later decrypt the cast votes.

3. The counter sends the ballots to the distributor.

4. The counter sends a copy of the decryption table to the verifier.

5. The counter sends the match pairings (pairs of a ballots encrypted and decrypted choices) to the matcher.

6. The registrar sends the authenticator a list of ID's that are eligible for the given election. If desired, the registrar may publish the names of these voters.

7. If desired, the verifier can check the ballots and pairings to confirm that they were properly generated.

Voting Phase

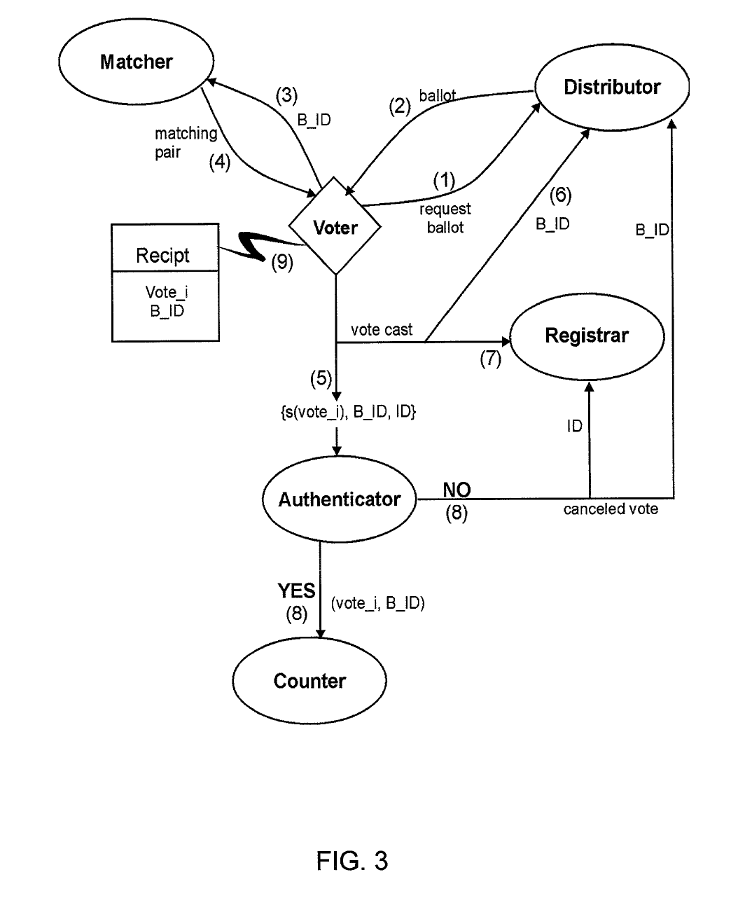

The voting phase consists of nine steps, with the voter participating in eight of the steps. The interaction between facilities is depicted in FIG. 3.

1 . When the voter wishes to participate in the election, he/she contacts the distributor and asks for a ballot.

2. The distributor randomly selects a ballot and sends it to the voter.

3 . The voter's Web browser requests the matching pair for the received ballot from the matcher.

4. The matcher sends the voter the appropriate matching pair.

5. The voter then signs the encrypted version of the desired vote using his/her signature key s and sends them to the authenticator, along with the ballot's ID number, and the voter's own ID.

6. The voter's Web browser informs the distributor that the ballot with the given ballot ID has been cast. (In so doing, the distributor has a record of how many votes are actually cast, and by which ballots. This will prevent any facility from generating votes for unused ballots, solving a major problem in many of the previously discussed protocols.)

7. The voter's Web browser informs the registrar that the voter has cast a vote, but it is not required to tell the registrar which ballot ID it used.

8. The authenticator first checks the signature to authenticate the voter. The authenticator then verifies that the authenticated voter is permitted to vote in the given election. Once authenticated, the authenticator passes only the legitimate encrypted vote and the ballot's ID to the counter. If authentication fails, the authenticator will notify the voter that he/she is not allowed to vote. The authenticator would then notify the registrar and distributor with a cancellation.

9. The voter's browser generates a receipt when the authenticator confirms receiving the ballot packets.

Announcement Phase.

The announcement phase requires no interaction between the different facilities. Each facility merely releases certain information to the public. To verify the integrity of the election, the verifier facility compares certain published lists. An individual voter could also compare some of these lists. The integrity of the election does not require a voter to do so, but allowing a voter to perform such checks increases the security as explained in Lemma 3 of Section 6.

The counter decrypts the votes it has received and tallies the vote.

The authenticator publishes list #1 containing the encrypted ballots and the ballot ID.

The counter publishes list #2 containing its version of list #1. Both lists 1 and 2 should be identical.

The authenticator publishes list #3 consisting of all voter IDs that cast ballots (in numerical order).

The registrar looks at list #3 and confirms that only valid voters voted. (This list could also be published if desired.)

The verifier confirms that lists 1 and 2 are identical. (To prevent cover-ups, it may be desirable to have lists 1 and 2 be sent to the verifier before they are published.)

The verifier uses list 1 and the decryption table (from counter in the pre-voting phase) to confirm the results published by the counter.

Voters can look at lists 1 and 2 to see their votes on both of these lists.

The distributor looks at lists 1 and 2 to be ensured that only legitimate ballots appear. Any illegal ballots can than be removed and the results recalculated. The distributor could also release its list of ballot ID's, but this should be done after the authenticator and the counter released their encrypted ballot lists.

The counter announces the election results, which can be verified by the verifier.

Remark.

Revealing the source code, much in the same way as with PGP, could allow laymen to check the validity and honesty of the facilities.

Ballot & Matching Pair Construction.

A basic ballot that is generated by the counter contains three items. The first is a ballot number. Depending upon the implementation of our protocol, the ballot number would contain sections for the district and election numbers. The remaining two items are lists. One list contains a plain-text version of the ballot choices. The next list contains the ballot choices after being encrypted using the encryption key for the ballot. The two lists are permutated, making it impossible to pair the plain-text choice with the encrypted choice without the matching pair for that particular ballot.

The matching pair contains the ballot number and a list of paired numbers. The first number in the pairing corresponds to the plain-text choice. The second number corresponds to the encrypted choice that matches the plain-text version of the first number.

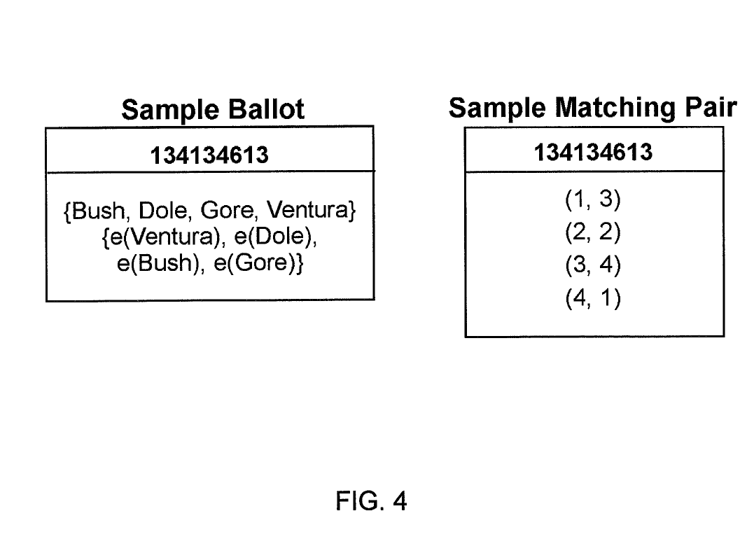

FIG. 4 shows a sample ballot and its corresponding matching pair. The ballot number is 134134613. The four possible choices on this ballot are Bush, Dole, Gore, and Ventura. The notation e(Dole) represents Dole after being encrypted with the ballot's key. The matching pair (1,3) designates that the third encrypted choice, e(Bush), corresponds to the first plain-text choice, Bush.

### CHAPTER V

### SECURITY MEASURES AND IMPLEMENTATION

To ensure that elections are held fairly, we must develop security measures to prevent individual modules of our voting system from conspiring with each other. We require that each of the facilities generate a pair of public and private keys of its own. These pairs should be replaced from time to time. To keep elections from being delayed, we recommend changing the keys between elections. We assume that not all of the facilities can be compromised at the same time. This is a reasonable assumption, for there is little one can do if all of the facilities are compromised simultaneously. In any conventional voting system, the overall security and integrity rely on humans. This means that the integrity of a traditional election is only as strong as that of the people running it. We will use a public-key encryption/decryption, scheme where keys commute. To prevent facilities from communicating illegally, all facilities will monitor the facility-facility communication channel.

5.1. Data Protection.

Each facility is required to encrypt its database (list of data) on the fly, e.g., one record at a time, using the public keys of all the facilities. By doing so, the only way to completely decode a piece of data would be to acquire the secret keys of all severs, which, by our assumption, is impossible. Because the database is encrypted piece by piece, the facility can easily extract the portion of the data from the database it needs to see and then sends it to the other facilities to decrypt it.

It is not necessary to encrypt election results, as they will be released at the end of the election. It would also be very easy to see any discrepancy in the results when all of the lists are released. It is necessary to encrypt the database of the distributor to protect the ballots that have not been given out.

5.2. Security of Communication Channels.

We have two type of communication to deal with. The first type is between facilities, and the second type is between a voter and a facility.

Facility-Facility Communication.

For communications between facilities, we need to ensure that these communications cannot be intercepted or altered; we also need to ensure that facilities do not collaborate to compromise the integrity or anonymity of the election. We accomplish both of these goals using the following protocol. When facility A wants to transmit data to facility B, facility A sends the encrypted data to a randomly selected third facility C. Facility C then decrypts the data with its own secret key, verifies that the size and the structure of the data it received have not been altered, and sends the data to another randomly selected facility D. The process is continued until the data finally reaches facility B, and facility B will be able to read the data after it uses its private key to decrypt the data.

Since intermediate facilities cannot completely decrypt the data, they will not know what exactly is being sent. The protocol can ensure that the information being sent is of legitimate size and structure. The only way for an intermediate facility to cheat would be to rearrange the information so it matches this size and structure. This would cause some information, such as some of the ballots to be left off, but the other facilities would be able to notice this when tabulation occurs.

Since facilities could manipulate this process by breaking the illegal data into small parts and reporting sizes that make the data appear legitimate. The facilities should each keep a log of the status of the protocol. This way communication can only occur between two facilities at appropriate times and should be limited as to how many communications they are permitted.

To reduce the amount of traffic, as well as decryption computation, communication between facilities should be done in large blocks. For instance, the counter should send all of the ballots to the distributor, and the authenticator should send the counter encrypted ballots in a large number of blocks.

Voter-Facility Communication.

Since we are dealing with the Internet, the most logical form of security for the interaction between the voter and the central facility would be to use HTTPS. HTTPS is already considered to be a secure form of communication for the Internet. It is considered to be a defacto standard; as long as it is viewed as such, it would be reasonable to use HTTPS. If circumstances cause a new standard to arise, this new standard should be adopted for this type of communication.

The only alteration to the HTTPS protocol we will have to deal with is the fact that when the voter is being sent something it would be encrypted. Of course, the facility also would not be able to look up the requested information. Therefore, the facility encrypts the database and sends it to the other facilities to remove their encryption. The facility gets the information back, decrypts it with its secret key and then looks up the requested information.

5.3. Denial of Service Attacks.

In order to ensure that a system designed using our protocol will work properly; we must devise a way to protect against someone using a denial of service attack. Otherwise, by preventing access to a certain district's servers, it would be possible to affect the results of an election. Those districts that traditionally vote one way could be targeted to prevent voters in those districts from being able to vote.

To get around these types of attacks, districts should be designed to share information. Each district would generate the ballots, matching pairs, and ballot decryption keys as previously described. Ballot IDs would contain a district ID, election ID, and the typical ballot ID. This would prevent districts from having duplicate ballot IDs.

Voters would register with their district. When it comes time to distribute their information, the districts would divide them into groups. Each of these groups would contain districts that traditionally vote differently. These groups would share ballot decryption keys, matching pairs, and valid voter IDs. To prevent the same ballot from being given out to multiple voters, the individual ballots would not be shared with the other districts.

When voters attempt to contact their district's server and are unable to retrieve a ballot due to a denial of service attack, they would be forwarded to the next server in the list. If they were denied service when they attempt to submit their vote, they would be forward onto the next server. Since all the servers know who can vote, and how to decrypt ballots, any facility can tally the vote. Results from the facilities would then be combined as a whole and compared instead of comparing each district's results individually.

For local elections, where voters' ballot is specific to their district, each district would send a chunk of the district's ballots to each of the districts in their group. When a voter requests a ballot, the voter would be given a ballot from his district's ballot box. Each district would be pulling ballots out of a ballot box containing unique ballots for whichever district the voter belongs to.

5.4. Buying Votes or Kidnapping Voters.

The ability of one party of candidate to buy votes, or simply force voters to vote a particular way is increased when an election is held electronically. A candidate could pay potential voters to vote for them and then watch them vote. Likewise, a candidate could kidnap people and force them vote a particular way.

To some degree, if we allow voters to change their vote, our protocol protects against these two types of attacks. The candidate attempting to buy votes would have no guarantee that the voter does not go back and alter their vote. If the candidate buying votes does not watch the voter vote, but merely requires the voter to show a receipt, then since the receipt only contains the encrypted ballot, the candidate has no way to guarantee that the voter voted as the desired.

Kidnapping voters would require that all the kidnapped voters be held until after the voting phase has ended. If released earlier, voters could change votes. They would also be required to be kidnapped before the process begins, otherwise they could vote before being kidnapped and then not properly sign their ballot, thus forcing the ballot to be rejected. Kidnapping large enough numbers of voters to affect an election and hold them for the duration of the election would easily be detected, and appropriate action could be taken.

### CHAPTER VI

### PROOF OF COMPLIANCE

In this chapter we provide proofs that our protocol satisfies all nine of the criteria defined in Chapter II. Recall that we assume that not all facilities collaborate at the same time. We first prove the following lemma.

Lemma 1.

If no facility knows all other facilities' secret keys, then any collaboration among facilities can be detected by a non-collaborating facility.

Proof.

We note that each facility's data is stored in an encrypted form with all the other facilities' public keys. The collaborating facilities cannot bypass the other facilities, because without them the data cannot be decrypted. Hence, the only way for two facilities A and B to collaborate is to cheat: The sending facility A does not encrypt the data and sends the data directly to the receiving facility B. Such activities can be detected by a non-collaborating facility C by monitoring the data transactions in the follow ways.

Case 1.

Facility A specifies that facility B is the destination facility and sends the data directly to B. Then the non-collaborating facility C can find out that A cheats because C must receive the data before B does.

Case 2.

Facility A specifies that facility B is not the destination, but picks B to be the first facility to pass the data. Then the non-collaborating facility C can find out that A cheats after a few rounds of transactions because A is supposed to randomly pick a third facility to send the data and C should have a chance to receive it in a few rounds.

The similar proof can be applied for the case where more than two facilities collaborate. This completes the proof.

Based on Lemma 1, we assume that no facilities collaborate in the rest of the proofs presented below.

Lemma 2.

The democracy criterion is satisfied.

Proof.

We assume that no cheating occurs in the registration phase; otherwise, there is little we can do no matter what voting protocol is used.

We first show that only eligible voters are allowed to vote. If an ineligible voter tries to vote, the authenticator can notice this and will not allow the vote to be cast. If the authenticator cheats by allowing an ineligible voter to participate in the election, the registrar will notice this when it receives the list of ID's that voted. If the registrar allows an ineligible voter to vote, then either too many voters would be permitted to vote, or an eligible voter would be denied the right to vote by the authenticator. In the first case, since we know the exact number of eligible voters for the given election in the registration phase, the authenticator or the counter would notice that too many people were being allowed to participate. In the second case, the voter will be notified and so the voter can challenge the registrar or the authenticator. The voter could request the registrar to inform the authenticator that he/she is eligible, which may then result in the first case.

Next, we show that each eligible voter can only vote once. If a voter tries to vote twice, the authenticator would notice that the signature key s and ID had already been used. Depending upon the voting scenario, the new vote would either overwrite the old vote, or it would simply be ignored. If the authenticator tries to pass the new vote on anyway, it would have to place it in place of someone else's vote, because otherwise the lists posted at the end would not match in length. The registrar, however, has it's own list of voters, and their ID's that actually voted. Eventually, there would be a conflict with these lists. This completes the proof.

Lemma 3.

The accuracy criterion is satisfied.

Proof.

Due to the fact that voters are given a receipt, and that they are allowed to view the published lists as described in the Announcement Phase, a voter's vote cannot be altered, duplicated, or removed without being detected. An attempt to alter or remove votes would be futile since the cheating party would not know which voters are going to check for their ballot. If a cheater changes a ballot and the voter whom cast the ballot examines the list, it would be evident that fraud had occurred. Appropriate measures could than be taken to remedy the error. In a large scale election, the cheater would be required to alter many ballots, increasing the likely hood of being caught.

There are three kinds of votes that are considered invalid, namely, votes made by ineligible voters, votes made by eligible voters but the votes are in incorrect formats, and votes generated by central facilities for unused ballots. For the first kind of invalid votes, as shown in the proof of Lemma 2, they will be detected before the final result is announced, and so they will not be counted. For the second kind of invalid votes, the counter will not be able to tally them since they are in wrong formats. For the third kind of invalid votes, since many lists are published at the end of the election, no facility can generate votes for unused ballots without being detected. This completes the proof.

Lemma 4.

The privacy criterion is satisfied.

Proof.

The only facility that can see the voters' names is the registrar. The registrar, however, can only see the encrypted ballot cast by a particular voter's ID. The registrar has no way to decrypt this vote without collaborating with the counter. We have shown in Lemma 1 that this can not occur.

Lemma 5.

The verifiability criterion is satisfied.

Proof.

Voters can be sure that their votes were tabulated by verifying that their ID and encrypted key are in the lists posted by the authenticator and the counter. Moreover, the voters are not relied upon to verify their votes because this is the job of the verifier. Although we do not require voters to check their ballots, it can be assumed that some will. Therefore, since the verifier does not know who will check their ballots, the verifier cannot cheat without being detected.

Lemma 6.

The simplicity criterion is satisfied.

Proof.

The voter is required to do very little, except that he/she needs to register and vote. The facilities do the majority of the work, with the voter's computer doing very minor calculations, and voters can vote with minimal equipment and skill.

Lemma 7.

The mobility criterion is satisfied.

Proof.

This is straightforward since our protocol is to be used over the World Wide Web. A voter can participate in the election anywhere there is access to the Internet.

Lemma 8.

The efficiency criterion is satisfied.

Proof.

As we mentioned earlier that in our protocol, the facilities do the most of the computations. In particular, all the calculations, except the signatures, are done before the voting even occurs. This means that very little time is consumed in the actual voting process. The main delay in voting would be the actual network communication. If the voting population were divided into districts the network delay would be minimal. Keeping the facilities in a close physical proximity, connected via a high-speed network, would also minimize delays. We can run the facilities using powerful computers (or special-purpose computers) to increase efficiency.

Lemma 9. The scalability criterion is satisfied.

Proof.

Since our protocol is to be run over the World Wide Web, it is easily scalable and divisible. If districts are desired or needed, our protocol will compensate for that by having each district running its own facilities. Large-scale elections would run smoother if they were partitioned, but it is not necessary to do so.

Lemma 10.

The responsibility criterion can be satisfied.

Proof.

As we mentioned before that the responsibility criterion is an optional requirement, which is not required in the US elections. But it is desirable in Australian elections. If this criterion is desired, the registrar can easily make it possible by publishing the names that have voted.

### CHAPTER VII

### ADDITIONAL PROPERTIES

In addition to the properties we proved in Chapter VI, we outline below some additional properties of our voting protocol.

Our protocol can be easily modified to allow the facilities to hold multiple elections simultaneously. For instance, we can participate in a nationwide election at the same time we vote for local officials or ordinances. This could be achieved by adding an election ID to the ballots. The ID would tell the facilities what election the given ballot is for. Voters would request a set of ballots instead of a single ballot.

Voters may be allowed to change their vote. This could be done in one of two ways. First, authenticator holds all votes till the end, to change a vote, the user just resubmits their vote. The authenticator throws out the old vote and keeps the new one. Second, when the authenticator sees that the voter has already cast his/her ballot for the given election, the authenticator asks the counter to remove the ballot from its list. The authenticator then sends the new vote to the counter. As an added benefit of this property, we can make vote selling more difficult, because the buyer now has to lock the seller until the end of the election to prevent the buyer from changing his/her vote.

If voters were permitted to change their vote, the threat of organizations buying votes would be eliminated. Organizations could not be guaranteed that the voter would not alter their vote after being paid. Organizations could still kidnap voters and force them to vote a particular way, but this would be much easier to detect than simply paying the poor for their votes.

Our protocol can handle many types of elections (e.g., several candidates, picking multiple candidates, write-in), with very limited modification.

Interested parties could have their own facilities designed to check the integrity of the election.

Using the distributor facility, we are allowing elections to occur on the Internet without worrying about hiding or masking IP addresses. The distributor facility also provides additional reliability on the integrity of the election.

Final Remark.

If the parties running the individual facilities would not collaborate (e.g., due to conflict interests) and they are in a secure environment, then some of the security measures such as encrypting data using the public keys of all facilities could be removed.

With the rapid spread and availability of the required technology, it is only a matter of time before society turns to the need for electronic elections. Much like an old pair of jeans, society has outgrown the conventional election. However, before this can occur a way of holding elections electronically must be developed and tested. At least, it must be as simple to use, secure, and anonymous as the current system. Ideally, it should be superior to the conventional model, because it should not be limited to location, size, or the influence of those overseeing the election.

We have shown that existing schemes for electronic elections do not satisfy all of the requirements for an electronic election. As a result we have introduced a new schema that satisfies all of our requirements. In addition, we have provided logical proofs supporting our claims toward the satisfaction each of the requirements. We have also suggested several techniques for securing this protocol to fit the needs and environment of the election. While the scheme has not been implemented, we have shown that the techniques supporting the scheme are fundamentally solid.

Our invention is a new electronic voting protocol that can be used on large-scale online elections. In particular, our protocol satisfies the following requirements:

1. Democracy: Only eligible voters are permitted to vote, and they can do so only once.

2. Accuracy: A voter's vote cannot be altered, duplicated, or removed without being detected. Invalid votes are not tabulated in the final tally.

3. Privacy: Votes remain anonymous.

4. Verifiability: Voters can be sure that their votes are tabulated correctly, but voters are not required to verify their votes in order to ensure election integrity.

5. Simplicity: Voters can finish voting quickly, with minimal equipment or special skills.

6. Mobility: Voters are not restricted to physical location from which they can cast their votes.

7. Efficiency: The election can be held in a timely manner (i.e. all computations during the election are done in a reasonable amount of time and voters are not required to wait on other voters to complete their ballot).

8. Scalability: The size of the election will not drastically affect performance.

9. Responsibility: Eligible voters who have not voted can be identified. (This is an optional requirement.)

Our protocol uses a secure form of communication (e.g. HTTPS in Netscape) for all transactions over the World Wide Web. In particular, our protocol consists of four phases (procedures), which are explained below. The phases are registration, pre-voting, voting, and announcement. For clarity, our protocol uses six central facilities. They are the registrar, the authenticator, the distributor, the counter, the matcher, and the verifier. The responsibilities of these facilities will become clear when the protocol phases are described. To reduce costs, in actual implementation it may be possible to combine some facilities, but in doing so one must first ensure that the combined facility will not have access to extra information that would allow the facility to compromise the election process in any way.

Registration Phase.

Four steps are involved in the registration phase. The voter only participates in two of the steps. FIG. 1 shows a visual representation of the communication between the acting facilities.

10. In order to vote, a voter must first register with the registrar to identify himself as an eligible voter.

11. Upon registering, the registrar assigns a unique identification number to the voter, places the voter's name and ID in the registered voter list, and sends the ID without the name to the authenticator.

12. For each ID it receives, the authenticator generates a unique pair of public/private keys (Pub_Key_{ID}, Priv_Key_{ID}), stores (ID, Pub_Key_{ID}) in a list, and sends (ID, Priv_Key_{ID}) to the registrar.

13. The registrar then sends the pair (ID, Priv_Key_{ID}) back to the voter. (In so doing, the authenticator will not know whom the given key Priv_Key_{ID} belongs to without conspiring with the registrar. The voter uses his/her key Priv_Key_{ID} to sign his/her ballot in the voting phase.)

Remark.

The signature key Priv_Key_{ID} may be valid for a long time for multiple elections, or could expire after a given time. If the key were to be kept for a long duration, it would probably be best to have the voter encrypt it with a password of his/her choice, so that no one else could use it. The original, unencrypted key would be destroyed and the encrypted key would be stored instead. The voter-encrypted key could be stored on the voter's license or identification card. Even if a license were stolen, a thief would not be able to vote as the voter, since the voter's key is encrypted. In addition, when the individual whose license was lost or stolen goes to get a new license, he/she would also be forced to re-register for a new key; and the old key would be revoked.

If a voter does not have a signature key yet, he/she is required to visit the DMV or other such agencies to have his/her identity verified and obtain a signature key. After a voter obtains a signature key, he/she is no longer required to visit the DMV for a new signature key; for the existing key can be used to verify his/her identity electronically.

Pre-voting Phase.

The pre-voting phase consists of six steps, with a seventh optional step. See FIG. 2 for a visual representation of the facility interaction.

14. The registrar sends the number of eligible registered voters to the counter.

15. The counter generates a larger number of ballots than the number of registered voters. Each ballot consists of three things: each of the choices on the ballot, an encrypted version of each choice, and a ballot ID. The counter keeps record of the decryption key and the ballot ID for each ballot so that the counter can later decrypt the cast votes. The counter keeps a record of mappings of ballot choices to encrypted ballot choices for each ballot.

16. The counter sends the ballots to the distributor.

17. The counter sends a copy of the decryption table to the verifier.

18. The counter sends the match pairings (mapping of a ballots encrypted to decrypted choices) to the matcher.

19. The registrar sends the authenticator a list of ID's that are eligible for the given election. If desired, the registrar may publish the names of these voters.

20. If desired, the verifier can check the ballots and pairings to confirm that they were properly generated.

Voting Phase.

The voting phase consists of nine steps, with the voters, or their browsers, participating in eight of the steps. The majority of these steps are simple Web transactions. The interaction between entities is depicted in FIG. 3.

21. When the voter wishes to participate in the election, he/she contacts the distributor and asks for a ballot.

22. The distributor randomly selects a ballot and blindly sends it to the voter.

23. The voter's Web browser requests the matching pair for the received ballot from the matcher.

24. The matcher sends the voter the appropriate matching pair.

25. The voter then signs the encrypted version of the desired vote using his/her signature key Priv_Key_{ID} and sends it to the authenticator, along with the ballot's ID number, and the voter's ID.

26. The voter's Web browser informs the distributor that the ballot with the given ballot ID has been cast. (In so doing, the distributor has a record of how many votes are actually cast, and by which ballots. This will prevent any facility from generating votes for unused ballots, solving a major problem in many of the previously discussed protocols.)

27. The voter's Web browser informs the registrar that the voter has cast a vote, but it is not required to tell the registrar which ballot ID it used.

28. The authenticator first checks the signature to authenticate the voter. The authenticator then verifies that the authenticated voter is permitted to vote in the given election. Once authenticated, the authenticator passes only the legitimate encrypted vote and the ballot's ID to the counter. If authentication fails, the authenticator will notify the voter that he/she is not allowed to vote. The authenticator would then notify the registrar and distributor with a cancellation.

29. The voter's browser generates a receipt when the authenticator confirms receiving the ballot packets.

Announcement Phase.

The announcement phase requires no interaction between the different facilities. Each facility merely releases certain information to the public. To verify the integrity of the election, the verifier facility compares certain published lists. An individual voter could also compare some of these lists. The integrity of the election does not require a voter to do so, but allowing a voter to perform such checks increases the security as explained in Lemma 3 of Section 6 of our paper [KW99], which is included as an attachment of this document.

The counter decrypts the votes it has received and tallies the vote.

The authenticator publishes a list, called List 1, containing the encrypted vote and the ballot ID.

The counter publishes a list, called List 2, containing its version of List 1. Both Lists 1 and 2 should be identical.

The authenticator publishes a list, called List 3, consisting of all voter IDs that cast ballots (in numerical order).

The registrar looks at List 3 and confirms that only valid voters voted. (The register could publish a list of all eligible voters if desired.)

The verifier confirms that Lists 1 and 2 are identical. (To prevent cover-ups, it may be desirable to have Lists 1 and 2 be sent to the verifier before they are published.)

The verifier uses List 1 and the decryption table (from counter in the pre-voting phase) to confirm the results published by the counter.

Voters can look at Lists 1 and 2 to see their votes on both of these lists. They can also check for their ID in List 3.

The distributor looks at Lists 1 and 2 to be ensured that only legitimate ballots appear. Any illegal ballots can than be removed and the results recalculated.

The distributor could also release its list of ballot ID's, but this should be done after the authenticator and the counter released their encrypted ballot lists.

The counter announces the election results, which can be verified by the verifier.

Remark.

Revealing the source code, much in the same way as with PGP, could allow laymen to check the validity and honesty of the facilities.

Ballot & Matching Pair Construction.

A basic ballot that is generated by the counter consists of three items. The first is a ballot number. Depending upon the implementation of our protocol, the ballot number would contain sections for the district and election numbers. The remaining two items are lists. One list contains a plain-text version of the ballot choices. The next list contains the ballot choices after being encrypted using the encryption key for the ballot. The two lists are permutated, making it impossible to pair the plain-text choice with the encrypted choice without the matching pair for that particular ballot.

The matching pair contains the ballot number and a list of paired numbers. The first number in the pairing corresponds to the plain-text choice. The second number corresponds to the encrypted choice that matches the plain-text version of the first number.

FIG. 4 shows a sample ballot and its corresponding matching pair. The ballot number is 134134613. The four possible choices on this ballot are Bush, Dole, Gore, and Ventura. The notation e(Dole) represents Dole after being encrypted with the ballot's key. The matching pair (1,3) designates that the third encrypted choice, e(Bush), corresponds to the first plain-text choice, Bush.

c. Expand on Novel and Unusual Features which Distinguish this Invention from Present Technology.

The current US government elections do not satisfy the verifiability criterion. If an election booth has malfunctions, for example, then some voters' ballots may not be counted correctly and the voters are not able to detect the error. In the past, elections have also been held in which ineligible voters, even the deceased, have been allowed to cast a vote.

Conventional election systems also do not handle mobility easily. Voters who will not be in their home districts during the election and wish to vote must file absentee ballots. But due to time constraints, this may not always be possible, as their absence may not be known until the last minute.

The idea of electronic election over computer networks has been studied intensively over the past fifteen years. A variety of cryptographic voting protocols have been proposed to minimize election fraud and maximize voter privacy (for example, see [Be87, BT94, Ch88, Co86, CF85, C+96, CGS, CC97, F+93, IV91, MV98, NS91, NS, N+91, Sal96, Sch96, SK94]). Most of the early-proposed protocols only deal with a few certain issues of elections, mostly for theoretical interests. As pointed out in [F+93] and [CC97], such protocols are impractical to implement for a large-scale geographically distributed voting district. For a survey of these protocols we refer the reader to Section 3.2 in Cranor and Cytron's paper [CC97], and in Chapter III of Karro's master thesis [Ka00]. So far there has not been a single government election done over the Internet. Fujioka, Okamoto, and Ohta [F+93] studied how to make online elections practical and proposed a voting protocol using cryptographic techniques of blind signatures and anonymous communication channels. Their protocol also uses central facilities to administrate elections and count votes. They justified that using central facilities is necessary for a voting scheme to be practical. Built on this work, Cranor and Cytron [CC97] recently designed and implemented a security-conscious polling system, called Sensus. However, Fujioka et al.'s protocol and the Sensus protocol suffer from several major drawbacks. These drawbacks are described in Section 3 of our paper [KW99], and in Chapter III of Karro's master thesis [Ka00]; both are attached to this document. Some of these drawbacks are due to the use of blind signatures in large scales and the unpractical assumption of using anonymous communication channels (Note that CPU identification numbers have been embedded into the new Intel's Pentium III chips that can be broadcast over the Internet). These drawbacks hinder Sensus from being used in large-scale elections. Our protocol is superior over all the previous protocols in that our protocol satisfies all the nine requirements mentioned in the beginning of item b. The correctness proof is given in Section 6 of our paper [KW99]. Moreover, our protocol also satisfies the following extra properties.

Our protocol can be easily modified to allow the facilities to hold multiple elections simultaneously. For instance, we can participate in a nationwide election at the same time we vote for local officials or ordinances. This could be achieved by adding an election ID to the ballots. The ID would tell the facilities what election the given ballot is for. Voters would request a set of ballots instead of a single ballot.

Voters may be allowed to change their vote. This could be done in one of two ways. First, the authenticator holds all votes till the end, to change a vote, the user just resubmits their vote. The authenticator throws out the old vote and keeps the new one. Second, when the authenticator sees that the voter has already cast his/her ballot for the given election, the authenticator asks the counter to remove the ballot from its list. The authenticator then sends the new vote to the counter. As an added benefit of this property, we can make vote selling more difficult, because the buyer now has to lock the seller until the end of the election to prevent the seller from changing his/her vote.

If voters were permitted to change their vote, the threat of organizations buying votes would be eliminated. Organizations could not be guaranteed that the voter would not alter their vote after being paid. Organizations could still kidnap voters and force them to vote a particular way, but this would be much easier to detect than simply paying the poor for their votes. Those being kidnapped would have to be held till the end of the voting process.

Our protocol can handle many types of elections (e.g., several candidates, picking multiple candidates, write-in), with very limited modification.

Interested parties could have their own facilities designed to check the integrity of the election. These facilities would only have to monitor the published lists, instead of monitoring the entire process.

Using the distributor facility, we are allowing elections to occur on the Internet without worrying about hiding or masking IP addresses. The distributor facility also provides additional reliability on the integrity of the election.

To ensure that elections are held fairly, we require that each of the facilities generate a pair of public and private keys of its own. These keys will be used to prevent individual modules in our voting system from conspiring with each other. These keys should be replaced from time to time. To keep elections from being delayed, we recommend changing the keys between elections. We assume that not all of the facilities can be compromised at the same time. This is a reasonable assumption, for there is little one can do if all of the facilities are compromised simultaneously. In any conventional voting system, the overall security and integrity rely on humans. This means that the integrity of a traditional election is only as strong as that of the people running it. We will use a public-key encryption/decryption, scheme where encryption and decryption commute with different keys. To prevent facilities from communicating illegally, all facilities will monitor the facility-facility communication channel.

Data Protection.

Each facility is required to encrypt its database (list of data) on the fly, e.g., one record at a time, using the public keys of all the facilities. By doing so, the only way to completely decode a piece of data would be to acquire the secret keys of all severs, which, by our assumption, is impossible. Because the database is encrypted piece by piece, the facility can easily extract the portion of the data from the database it needs to see and then sends it to the other facilities to decrypt it.

It is not necessary to encrypt election results, as they will be released at the end of the election. It would also be very easy to see any discrepancy in the results when all of the lists are released. It is necessary to encrypt the database of the distributor to protect the ballots that have not been given out.

Security of Communication Channels.

We have two types of communication to deal with. The first type is between facilities, and the second type is between a voter and a facility.

Facility-Facility Communication.

For communications between facilities, we need to ensure that these communications cannot be intercepted or altered; we also need to ensure that facilities do not collaborate to compromise the integrity or anonymity of the election. We accomplish both of these goals using the following protocol. When facility A wants to transmit data to facility B, facility A sends the encrypted data to a randomly selected third facility C. Facility C then decrypts the data with its own secret key, verifies that the size and the structure of the data it received have not been altered, and sends the data to another randomly selected facility D. The process is continued until the data finally reaches facility B, and facility B will be able to read the data after it uses its private key to decrypt the data.

Since intermediate facilities cannot completely decrypt the data, they will not know what exactly is being sent. The protocol can ensure that the information being sent is of legitimate size and structure. The only way for an intermediate facility to cheat would be to rearrange the information so it matches this size and structure. This would cause some information, such as some of the ballots to be left off, but the other facilities would be able to notice this when tabulation occurs.

Since facilities could manipulate this process by breaking the illegal data into small parts and reporting sizes that make the data appear legitimate. The facilities should each keep a log of the status of the protocol. This way communication can only occur between two facilities at appropriate times and should be limited as to how many communications they are permitted.

To reduce the amount of traffic, as well as decryption computation, communication between facilities should be done in large blocks. For instance, the counter should send all of the ballots to the distributor, and the authenticator should send the counter encrypted ballots in a large number of blocks.

Voter-Facility Communication.

Since we are dealing with the Internet, the most logical form of security for the interaction between the voter and the central facility would be to use HTTPS. HTTPS is already considered to be a secure form of communication for the Internet. It is considered to be a de facto standard; as long as it is viewed as such, it would be reasonable to use HTTPS. If circumstances cause a new standard to arise, this new standard should be adopted for this type of communication.

The only alteration to the HTTPS protocol we will have to deal with is the fact that when the voter is being sent something it would be encrypted. Of course, the facility also would not be able to look up the requested information. Therefore, the facility encrypts the database and sends it to the other facilities to remove their encryption. The facility gets the information back, decrypts it with its secret key and then looks up the requested information.

Denial of Service Attacks.

In order to ensure that a system designed using our protocol will work properly; we must devise a way to protect against someone using a denial of service attack. Otherwise, by preventing access to a certain district's servers, it would be possible to affect the results of an election. Those districts that traditionally vote one way could be targeted to prevent voters in those districts from being able to vote.

To get around these types of attacks, districts should be designed to share information. Each district would generate the ballots, matching pairs, and ballot decryption keys as previously described. Ballot IDs would contain a district ID, election ID, and the typical ballot ID. This would prevent districts from having duplicate ballot IDs.

Voters would register with their district. When it comes time to distribute their information, the districts would divide them into groups. Each of these groups would contain districts that traditionally vote differently. These groups would share ballot decryption keys, matching pairs, and valid voter IDs. To prevent the same ballot from being given out to multiple voters, the individual ballots would not be shared with the other districts.

When voters attempt to contact their district's server and are unable to retrieve a ballot due to a denial of service attack, they would be forwarded to the next server in the list. If they were denied service when they attempt to submit their vote, they would be forward onto the next server. Since all the servers know who can vote, and how to decrypt ballots, any facility can tally the vote. Results from the facilities would then be combined as a whole and compared instead of comparing each district's results individually.

For local elections, where voters' ballot is specific to their district, each district would send a chunk of the district's ballots to each of the districts in their group. When a voter requests a ballot, the voter would be given a ballot from his district's ballot box. Each district would be pulling ballots out of a ballot box containing unique ballots for whichever district the voter belongs to.

Buying Votes or Kidnapping Voters.

The ability of one party of candidate to buy votes, or simply force voters to vote a particular way is increased when an election is held electronically. A candidate could pay potential voters to vote for them and then watch them vote. Likewise, a candidate could kidnap people and force them vote a particular way.

To some degree, if we allow voters to change their vote, our protocol protects against these two types of attacks. The candidate attempting to buy votes would have no guarantee that the voter does not go back and alter their vote. If the candidate buying votes does not watch the voter vote, but merely requires the voter to show a receipt, then since the receipt only contains the encrypted ballot, the candidate has no way to guarantee that the voter voted as the desired. Kidnapping voters would require that all the kidnapped voters be held until after the voting phase has ended. If released earlier, voters could change votes. They would also be required to be kidnapped before the process begins, otherwise they could vote before being kidnapped and then not properly sign their ballot, thus forcing the ballot to be rejected. Kidnapping large enough numbers of voters to affect an election and hold them for the duration of the election would easily be detected, and appropriate action could be taken.

d. Comment on Possible Uses for the Invention.

Democratic societies are founded on the principle of elections. However, it is not unusual that many eligible voters in a democratic society do not participate in elections. One of the common reasons for not participating is that voters find it inconvenient to go to the polls. In conventional elections, voters must go to a designated location near their residence. However, for various reasons voters are not always able to make it to these locations. They may be out of town on work or on vacation. Even if they are in town, their daily schedule may not permit them to get to the ballots.

With the rapid growth of the Internet, specifically the World Wide Web, voting online provides a reasonable alternative and in the future may replace conventional elections. Voting online would allow voters to participate in an election in any location that provides Internet access. Voters could cast their ballots while at work, at school, or in the comfort of their own home. Many public libraries have computers with Internet access that could also be used in elections. In some places, bookstores and coffee bars are also starting to provide Internet access. For those voters still without Internet access, voting districts would still have designated locations; only computers, instead of voting booths, would be used. There would be no need to restrict voters to a given district.

We presented an early draft of this work [KW99] at the 15th Annual Computer Security Applications Conference held in Phoenix, Ariz. on Dec. 6-10, 1999. At the conference it was suggested that we seek private or government support to implement our protocol. We were also informed that the US government, particularly the Armed Forces which accounts for a large quantity of absentee ballots, were attempting to devise a way to hold elections online.

While the intention of this invention is to hold elections electronically, this invention could be used on a smaller scale also. It could be used for stockholder votes, union votes, and school elections. It could also be used for polls or surveys. If survey participants are to receive rewards for participating, they could receive their reward while keeping their opinions anonymous.

### BIBLIOGRAPHY

[Be87] J. Benaloh. Verifiable Secret-Ballot Elections. PhD. Thesis, Yale University, 1987.

[BT94] J. Benaloh and D. Tuinstra. Receipt-free secret-ballot elections. In Proceedings of the 26^{th} ACM Symposium on Theory of Computing, pages 544-553, ACM Press, 1994.

[Ch82] D. Chaum. Blind signatures for untraceable payments. In Blind Signatures for Untraceable Payments, D. Chaum, R. Rivest, and A. Sherman, eds., pages 199-203, Plenum Press, 1982.

[Ch81] D. Chaum. Untraceable electronic mail, return addresses, and digital pseudonyms. Communication of the ACM, 24(1981), pp. 84-88.

[Ch88a] D. Chaum. The dinning cryptographers problem: unconditional sender and recipient untraceability. Journal of Cryptography, 1(1988), pp. 65-75.

[Ch88b] D. Chaum. Elections with unconditionally secret ballots and disruption equivalent to breaking RSA. In Proceedings of Advances in Cryptology (EUROCRYPT'88), vol. 330 of Lecture Notes in Computer Science, pages 177-182, Springer-Verlag, 1988.

[Co86] J. Cohen. Improving privacy in cryptographic elections. Yale University Tech. Rep. DCS/TR-454, 1986.

[CF85] J. Cohen and M. Fisher. A robust and verifiable cryptographically secure election scheme. In Proceedings of the 26^{th} IEEE Annual Symposium on Foundations of Computer Science, pages 372-382, IEEE Computer Society Press, 1985.

[C+96] R. Cramer, M. Frankin, B. Schoenmakers, and M. Yung. Multi-authority secret ballot elections with linear work. In Proceedings of Advances in Cryptology (EUROCRYPT'96), vol. 1070 of Lecture Notes in Computer Science, pages 7283, Springer-Verlag, 1996.

[CGS] R. Cramer, R. Gennaro, and B. Schoenmakers. A secure and optimally efficient multi-authority election scheme. Manuscript acquired from rosario@watson.ibm.com.

[Cr96] L. Cranor. Electronic voting: computerized polls may save money, protect privacy. ACM Crossroads (Electronic Journal), 1996.

[CC97] L. Cranor and R. Cytron. Sensus: A security-conscious electronic polling system for the Internet. In Proceedings of the Hawaii International Conference on System Sciences. Wailea, Hi., 1997.

[F+93] A. Fujioka, T. Okamoto. and K. Ohta. A practical secret voting scheme for large scale elections. In Proceedings of Advances in Cryptology (AUSCRYPT'92), vol. 718 of Lecture Notes in Computer Science, pages 244251, Springer-Verlag, 1993.

[KW99] J. Karro and J. Wang. Towards a Practical, Secure, and Very Large Scale Online Election. In Preceedings of the 15^{th} Annual Computer Security Applications Conference, pages 161-169, IEEE Computer Society. 1999.

[Iv91] K. Iversen. A cryptographic scheme for computerized general elections. In Proceedings of Advances in Cryptography (CRYPTO'91), vol. 576 of Lecture Notes in Computer Science, pages 405-419, Springer-Verlag, 1991.

[MV98] Y. Mu and V. Varadharajan. Anonymous secure e-voting over a network. In Proceedings of the 14^{th} Annual Computer Security Applications Conference, pages 293-299, IEEE Computer Society. 1998.

[Na90] M. Naor. Bit commitment using pseudo-randomness. In Proceedings of Advances in Cryptology (CRYPTO'90), vol. 435 of Lecture Notes in Computer Science, pages 218-229, Springer-Verlag, 1990.

[Ne93] P. Neumann. Security criteria for electronic voting. In Proceedings of the 16^{th} National Computer Security Conference, pages 478-481, 1991.

[NS91]H. Nurmi and A. Salomaa. A cryptographic approach to the secret ballot. Behavioral Science. 36(1991), pp. 34-40.

[NS] H. Nurmi and A. Salomaa. Secret ballot elections and public-key cryptosystems. Manuscript.

[N+91]H. Nurmi, A. Salomaa, and L. Santean. Secret ballot elections in computer networks. Computers & Security, 10(1991), pp. 553-560.

[Pf84] A. Pfitzmann. A switched/broadcase ISDN to decrease user obervability. In Proceedings of the International Zurich Seminar on Digital Communication, pages 183-190, IEEE Computer Society Press, 1984.

[Sal96]A. Salomaa. Public-Key Cryptography. 2^{nd} edition. Springer-Verlag, Berlin, 1996.

[Sch96] B. Schneier. Applied Cryptology, 2^{nd} edition. John Wiley & Sons, New York, 1996.

[SK94]K. Sako and J. Kilian. Secure voting using partially compatible homomorphisms. In Proceedings of Advances in Cryptology (CRYPTO'94), vol. 839 of Lecture Notes in Computer Science, pages 411-424, Springer-Verlag. 1994.

U.S. Pat. No. 6,021,200 to Fischer;

U.S. Pat. No. 4,764,120 to Griffin, et al.

U.S. Pat. No. 4,774,665 to Webb

U.S. Pat. No. 5,218,528 to Wise, et al.

U.S. Pat. No. 5,231,668 to Kravitz

U.S. Pat. No. 5,400,248 to Chisholm.

U.S. Pat. No. 5,495,532 to Kilian, et al.

U.S. Pat. No. 5,583,329 to Davis III, et al.

U.S. Pat. No. 5,875,432 to Sehr

U.S. Pat. No. 5,682,430 to Kilian, et al.

U.S. Pat. No. 5,878,399 to Peralto

U.S. Pat. No. 6,026,163 to Micali

The entire disclosure of each of the above documents is hereby incorporated by reference herein.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A method of holding an election comprising
enabling voters to register with a registrar facility including providing encryption keys to registered voters and storing the encryption key with an authenticator facility,
distributing ballots having unique ballot ID's to requesting voters,
receiving ballots having voter choices on them and encrypted using voters encryption keys,
receiving from voters
a) ballot ID, encrypted vote information and, voter ID at an authenticator facility,
b) indications that votes have been cast with a ballots having indicated ballot ID's at a distributor facility, and
a) an indication that the voter has voted at a registrar facility,
authenticating the voter at the authenticator facility and passing authenticated votes and the ballot ID to a counter facility.

2. A method as claimed in claim 1 further comprising
decrypting votes at the counter facility and tallying a number of votes,
publishing a list containing encrypted votes and ballot ID's at the authenticator facility,
publishing a list containing encrypted votes and ballot ID's at the counter facility,
publishing a list containing voter ID's of cast ballots at the authenticator facility,
examining the list containing voter ID's of cast ballots at the registrar facility to confirm that only registered voters voted,
verifying at a verifier facility that the list containing encrypted votes and ballot ID's published at the authenticator facility is identical to the list containing encrypted votes and ballot ID's published at the counter facility,
confirming at the verifier facility from the list containing encrypted votes and ballot ID's published at the authenticator facility and a decryption table the results published by the counter facility,
examining at the distributor facility the list containing encrypted votes and ballot ID's published at the authenticator facility and the list containing encrypted votes and ballot ID's published at the counter facility to ensure that only legitimate ballots appear, and
releasing the election results at the counter facility.

3. A method as claimed in claim 1 wherein at least one of the distributing and receiving steps includes transmitting information over the Internet.

4. A method as claimed in claim 1 wherein distributing ballots includes distributing a number of ballots from an inventory of ballots that has more members than there are registered voters.

5. A method as claimed in claim 1 wherein distributing ballots includes distributing a ballot having a ballot number, and a matching pair made up of plain-text versions of ballot choices and encrypted versions of ballot choices.

6. A method as claimed in claim 5 wherein the encrypted version is encrypted using an encryption key unique to the ballot.

7. A method as claimed in claim 5 wherein the ballot choices include ballot choices in municipal and national elections.

8. A method as claimed in claim 2 wherein the acts of publishing include publishing to the general public.

9. A method as claimed in claim 1 wherein passing authenticated votes includes passing data through a firewall.

10. An election apparatus comprising
a network of data handling devices configured to hold an election comprising
a data handling device enabling voters to register with a registrar facility including providing encryption keys to registered voters and storing the encryption key with an authenticator facility,
a data handling device distributing ballots having unique ballot ID's to requesting voters,
a data handling device receiving ballots having voter choices on them and encrypted using voters encryption keys,
data handling devices configured as authenticator, distributor and registrar facilities enabled to receive from voters
a) ballot ID, encrypted vote information and, voter ID at the authenticator facility,
b) indications that votes have been cast with a ballots having indicated ballot ID's at the distributor facility, and
c) an indication that the voter has voted at the registrar facility,
to authenticate the voter at the authenticator facility and passing authenticated votes and the ballot ID to a data handling device configured as a counter facility.

10. An election apparatus as claimed in claim 10 wherein at least two of the data handling devices communicate information to one another over the Internet.

11. An election apparatus as claimed in claim 10 wherein the data handling device that distributes ballots distributes a number of ballots from an inventory of ballots that has more members than there are registered voters.

12. An election apparatus as claimed in claim 10 wherein the data handling device that distributes ballots distributes a ballot having a ballot number, and a matching pair made up of plain-text versions of ballot choices and encrypted versions of ballot choices.

13. An election apparatus as claimed in claim 12 wherein the encrypted version is encrypted using an encryption key unique to the ballot.

14. An election apparatus as claimed in claim 12 wherein the ballot choices include ballot choices in municipal and national elections.

15. An election apparatus as claimed in claim 10 the authenticator is protected by a firewall.
